(19) United States
(12) Patent Application Publication
(10) Pub. No.: US 2016/0209940 A1
(43) Pub. Date: Jul. 21, 2016

(54) STYLUS SYNCHRONIZATION WITH A DIGITIZER SYSTEM

(71) Applicant: Microsoft Technology Licensing, LLC, Redmond, WA (US)

(72) Inventors: Ilan GELLER, Pardesia (IL); Uri Ron, Kfar-Saba (IL); Ahia PERETZ, Ramat-Gan (IL)

(21) Appl. No.: 14/914,072

(22) PCT Filed: Sep. 11, 2014
(86) PCT No.: PCT/IL2014/050808

§ 371 Date: Feb. 24, 2016

Related U.S. Application Data
(60) Provisional application No. 61/876,822, filed on Sep. 12, 2013.

(51) Int. Cl. G06F 3/038; G06F 1/32; G06F 3/041; G06F 3/044; G06F 3/0354

(52) U.S. Cl. CPC G06F 3/0383; G06F 3/044; G06F 3/03545; G06F 3/0416; G06F 1/325; G06F 1/3215; G06F 2203/04101

(57) ABSTRACT

A method for operating a stylus with a digitizer system includes receiving a signal that is repeatedly transmitted by the digitizer system according to a pre-defined protocol of the digitizer system, the protocol being known to the stylus, transmitting position signals in synchronization with the signal transmitted by the digitizer system, and continuing transmission of the position signals over a duration that the stylus receives the repeated transmissions of the digitizer system according to the pre-defined protocol.

### RELATED APPLICATION/S

This application claims the benefit of priority under 35 USC §119(e) of U.S. Provisional Patent Application No. 61/876,822 filed Sep. 12, 2013, the contents of which are incorporated herein by reference in their entirety.

### FIELD AND BACKGROUND OF THE INVENTION

The present invention, in some embodiments thereof, relates to a digitizer system operated with a signal emitting object and, more particularly, but not exclusively, to a digitizer system operated with a stylus.

Electromagnetic styluses and/or pens are known in the art for use and operation of a digitizer. Position detection of the stylus provides input to a computing device associated with the digitizer and is interpreted as user commands Position detection is performed while the stylus tip is either touching and/or hovering over a detection surface of the digitizer. Often, the digitizer is integrated with a display screen and a position of the stylus over the screen is correlated with virtual information portrayed on the screen.

U.S. Pat. No. Publication No. 2014-0240298 entitled “Stylus for a Digitizer System,” assigned to N-trig Ltd., the contents of which is incorporated herein by reference, describes an active stylus with a resonant circuit that alternates between being operated in a receive mode for picking up a synchronization and/or triggering signal emitted by a digitizer system and being operated in a transmit mode for transmitting a signal powered by the power source. The resonant circuit switches from the receive mode to the transmit mode responsive to picking up the synchronization and/or triggering signal emitted by the digitizer system. At the end of the transmission period, the resonant circuit is switched back to a receive mode.

U.S. Pat. No. 8,481,872, entitled “Digitizer, Stylus and Method of Synchronization Therewith,” assigned to N-trig Ltd., the contents of which is incorporated herein by reference, describes a method for operating a digitizer sensor with an autonomous asynchronous stylus that transmits signal bursts at a defined rate. The method includes sampling outputs from a digitizer over a plurality of chunk sampling periods that are staggered with respect to a refresh cycle of the digitizer. A chunk sampling period over which a signal burst transmitted from the stylus is detected is identified. A timing of signal bursts over subsequent refresh cycles is determined and used to synchronize the refresh cycle of the digitizer with the transmission repeat cycle of the stylus in accordance with the timing of the signal bursts.

U.S. Pat. No. 7,292,229 entitled “Transparent Digitizer” which is assigned to N-trig Ltd., the contents of which is incorporated herein by reference, describes a digitizer integrated with a display screen and operated with a stylus. The digitizer includes an excitation coil that surrounds its sensing area. The excitation coil provides a trigger pulse that excites a passive resonant circuit in the stylus for producing a response from the stylus that can subsequently be detected by the digitizer. It is described that an advantage of external excitation is that it inherently provides synchronization of the stylus to the digitizer, since both components are aware of the excitation pulse timing.

### SUMMARY OF THE INVENTION

According to an aspect of some embodiments of the present invention there is provided a stylus for operation with a digitizer that is operable to synchronize with sampling periods of the digitizer. According to some embodiments of the present invention, the stylus synchronizes periodic pulsed transmissions with a synchronization signal received from the digitizer system and/or touch screen device. According to an aspect of some embodiments of the present invention, the stylus may be maintained in a sleep mode whenever synchronization signal is received from the digitizer system.

An aspect of some embodiments of the present invention provides for a method for operating a stylus with a digitizer system, the method comprising: receiving a signal that is repeatedly transmitted by the digitizer system according to a pre-defined protocol of the digitizer system, the protocol being known to the stylus; transmitting position signals in synchronization with the signal transmitted by the digitizer system; and continuing transmission of the position signals over a duration that the stylus receives the repeated transmissions of the digitizer system according to the pre-defined protocol.

Optionally, the method includes: operating the stylus in a sleep mode, wherein the stylus is powered to receive input during the sleep mode but is not powered to transmit the position signals during the sleep mode; receiving the signal that is repeatedly transmitted by the digitizer system while the stylus is in the sleep mode; switching the stylus to a wake-up mode responsive to detecting the signal transmitted by the digitizer system; and maintaining the stylus in the wake-up mode over the duration that the stylus receives the repeated transmissions of the digitizer system according to the pre-defined protocol.

Optionally, the method includes reassuming a sleep mode after a pre-defined period in which the signal transmitted by the digitizer system is not received.

Optionally, the method includes powering generation of the position signal with a power source internal to the stylus responsive to switching the stylus to a wake-up mode.

Optionally, the method includes powering a tip pressure sensor within the stylus responsive to switching the stylus to a wake-up mode.

Optionally, the method includes the synchronization includes transmitting the position signals with a pre-defined delay from receipt of the signal transmitted by the digitizer system.

Optionally, the signal received by the stylus is encoded with information for synchronizing transmission of the position signal and wherein the stylus decodes the information and uses it to synchronize transmission of the position signal.

Optionally, the encoded information includes a defined delay period for transmitting the position signal.

Optionally, the method includes adjusting the synchronization of the stylus during the repeated transmissions of the digitizer system.

Optionally, the signal transmitted by the digitizer system and received by the stylus is selected from a group including: an electromagnetic signal, an RF signal, a sonic signal, and an optical signal.

Optionally, the optical signal is provided by a display screen associated with the digitizer system.

Optionally, the optical signal is a synchronization signal associated with a refresh timing of a display screen of the digitizer system.

Optionally, the pre-defined protocol of the digitizer system is synchronized with sampling windows of the digitizer system for sampling output from a digitizer sensor of the digitizer system.

Optionally, the position signal is a pulse signal that is transmitted according to the pre-defined protocol of the digitizer system.

Optionally, the method includes transmitting with the stylus an encoded signal in synchronization with the timing at which the signal is received.

Optionally, the encoded signal includes information regarding tip pressure applied on a tip of the stylus.

Optionally, the encoded signal includes information regarding one or more of the following: stylus identification, battery power state, and state of user activated buttons.

Optionally, the digitizer system includes a digitizer sensor that is a grid based capacitive sensor.

Optionally, the signal transmitted by the digitizer system is transmitted by conductive lines of the grid based capacitive sensor.

Optionally, the digitizer system is operated to detect finger touch.

Optionally, the signal transmitted by the digitizer system is transmitted concurrently with triggering the grid based capacitive sensor for fingertip touch detection.

Optionally, the signal transmitted by the digitizer system is transmitted with a conductive loop patterned around a sensing surface of the digitizer system.

Optionally, the signal transmitted by the digitizer system is transmitted with an RF link included in a host computer associated with the digitizer system.

Optionally, the digitizer system includes a touch screen.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified block diagram of an exemplary digitizer system in accordance with some embodiments of the present invention;

FIG. 2 is a simplified block diagram showing exemplary components of a stylus in accordance with some embodiments of the present invention;

FIGS. 3A-3C are simplified schematic drawings of styluses including a microphone, an RF link device, and a plurality of photo-detectors respectively, all in accordance with some embodiments of the present invention;

FIG. 4 is a simplified flow chart of an exemplary method for operating a stylus in accordance with some embodiments of the present invention;

FIG. 5 is a simplified time diagram illustrating a method for waking up a stylus and synchronizing its transmission with a corresponding sampling window of a digitizer system in accordance with some embodiments of the present invention;

FIG. 6 is a simplified time diagram illustrating a method for resuming a sleep mode in accordance to some embodiments of the present invention;

FIG. 7 is a simplified time diagram illustrating a method for operating a stylus during a hover and a touch operational state in accordance with some embodiments of the present invention;

FIGS. 8A and 8B are simplified flow charts of an exemplary method for using an RF link for establishing two-way communicating between a stylus and a digitizer system in accordance with some embodiments of the present invention; and

FIG. 9 is a simplified flow chart of exemplary method for synchronizing transmission of a stylus with a digitizer system by detecting timing of screen refresh in accordance with some embodiments of the present invention.

### DESCRIPTION OF SPECIFIC EMBODIMENTS OF THE INVENTION

The present invention, in some embodiments thereof, relates to a digitizer system operated with a signal emitting object and, more particularly, but not exclusively, to a digitizer system operated with a stylus.

According to some embodiments of the present invention, there is provided a method for synchronizing transmission of a stylus with sampling periods of a digitizer system such that the digitizer system is the master device and the stylus is the slave device. According to some embodiments of the present invention, a digitizer system transmits synchronization signals that are to be picked up by the receiver of the stylus when the stylus is in the vicinity of its digitizer sensor. Typically, the synchronization signals are transmitted based on protocol of the digitizer system that is known to the stylus. Optionally, the synchronization signal is transmitted at a pre-defined rate that is known to the stylus, e.g. once per refresh cycle of the digitizer system.

According to an aspect of some embodiments of the present invention, there is provided a stylus that assumes a sleep mode while positioned away from an operating digitizer sensor and switches to an operating state as it approaches the operating digitizer sensor. According to some embodiments of the present invention, a low power receiver remains active during the sleep mode and detects when the stylus is near the operating digitizer sensor.

According to some embodiments of the present invention, the stylus determines that it is within an operating distance from the digitizer sensor responsive to picking up one or more of the synchronization signals transmitted. According to some embodiments of the present invention, the stylus both wakes-up its operation and also synchronizes its transmission in response to picking up the synchronization signal.

According to some embodiments of the present invention, transmission and/or operation of the stylus in wake-up mode continues as long as the receiver continues to detect the synchronization signals.

In some exemplary embodiments, the stylus is operated to initiate its transmission at a pre-defined delay from reception of the synchronization signal.

Optionally, the synchronization signal includes encoded information that includes instructions for synchronizing, e.g. a defined timing for initiating transmission.

According to some embodiments of the present invention, synchronization is adjusted as needed during operation of the stylus. According to some embodiments of the present invention, the stylus reassumes a sleep mode when the synchronization signal is lost. Various non-limiting methods are proposed for transmitting and receiving the synchronization signal as will be described in further detail herein.

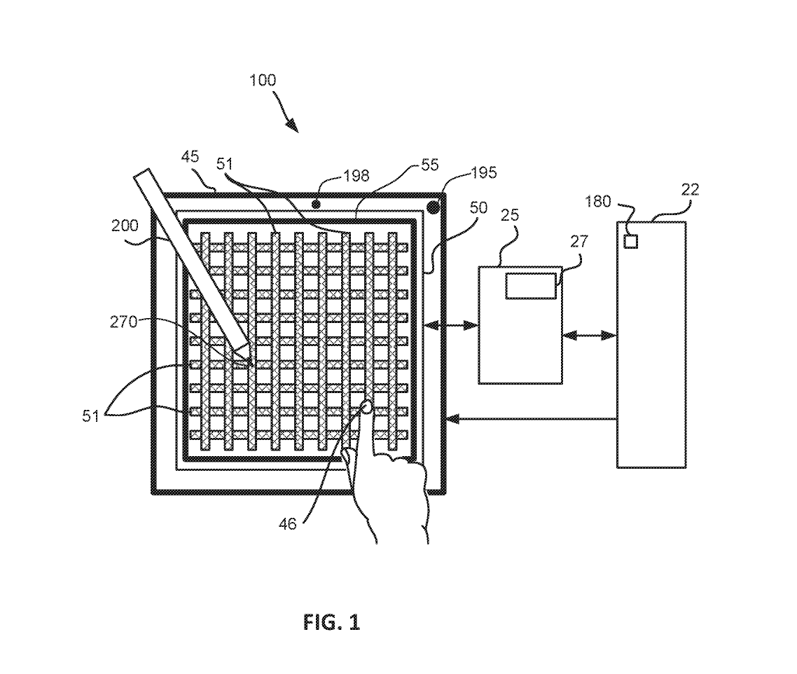

Referring now to the drawings, FIG. 1 illustrates a simplified block diagram of an exemplary digitizer system in accordance with some embodiments of the present invention. According to some embodiments of the present invention, digitizer system 100 includes a digitizer sensor 50 and circuitry 25 for sampling and processing output from sensor 50. Typically, output from circuitry 25 is forwarded to a host 22 via an interface for processing by an operating system or an application running on host 22.

Optionally, sensor 50 is integrated, e.g. overlaid on a flat panel display (FPD) 45 and digitizer system 100 is a touch screen.

Typically, sensor 50 includes a patterned arrangement of conductive strips or lines 51 that are optionally arranged in rows and columns to form a grid of conductive strips 51, also referred to as antennas or conductors. In some exemplary embodiments, sensor 50 is transparent as when overlaid on FPD 45. According to some embodiments of the present invention, sensor 50 picks up signals emitted by stylus 200 and optionally also senses input provided by a fingertip hovering and/or touching a sensing surface of sensor 50 by capacitive methods. Typically, sensor 50 is a capacitive based sensor. Inputs from stylus 200 and fingertip 46 are typically sampled by circuitry 25 over separate sampling windows.

### Fingertip Sensing

According to some embodiments of the present invention, a mutual capacitance method is applied for sensing presence and tracking position of one or more fingertips 46 or other conductive objects on sensor 50. Exemplary, mutual capacitance methods for detecting fingertip touch and hover are described for example in U.S. Pat. No. 7,372,455 entitled “Touch Detection Method” and also in U.S. Pat. No. 7,902,840 entitled “Apparatus for object information detection and methods of using same,” both of which are assigned to N-trig Ltd. and incorporated herein by reference. Typically, when applying mutual capacitive sensing, circuitry 25 generates and sends a triggering pulse to one line 51 at a time along one axis of the grid while sampling output along the other axis of the grid.

Optionally, groups of lines 51 along one axis are triggered together. Typically, lines 51 are triggered with a train of triggering pulses transmitted at frequency of 10-500 KHz. Optionally, fingertip touch is alternatively and/or also detected using a self-capacitance method. An exemplary self-capacitance detection method is also described for example in incorporated U.S. Pat. No. 7,372,455 entitled “Touch Detection Method.” In a self-capacitance detection method, all lines 51 can be triggered simultaneously with the train of triggering pulses. Typically, circuitry 25 distinguishes between hover and touch of a fingertip 46 or conductive object.

### Stylus Communication and Sensing

According to some embodiments of the present invention, stylus 200 transmits a signal near its tip in response to detecting input from digitizer system 100. An exemplary construction for a tip and a stylus transmitting method is described for example in incorporated U.S. Pat. No. 7,292,229 entitled “Transparent Digitiser.”

According to some embodiments of the present invention, lines 51 of sensor 50 operate as antennas for picking up the signal transmitted by stylus 200 at a location near its tip. According to some embodiments of the present invention, the stylus signal picked up by lines 51 is used to determine and track position of the stylus 200. In some exemplary embodiments, the stylus signal includes encoded information and circuitry 25 decodes the information provided by the stylus. In some exemplary embodiments, information provided by stylus 200 includes for example tip pressure applied on the stylus tip, hover/touch state of stylus, stylus identification, battery charge level, and state of user activated button. In some exemplary embodiments of the present invention, circuitry 25 distinguishes between hovering and touch of stylus 200.

According to some embodiments of the present invention, the signal transmitted by stylus 200 is an oscillating pulse signal and/or signal burst that is transmitted once per transmission cycle of stylus 200. Optionally, the pulse duration is between 1.25-1.3 msec. Optionally, more than one pulse is transmitted during a transmission cycle, e.g. a train of pulses. Optionally, the oscillating signal that is used to generate the pulse has a frequency between 10-500 KHz. The signal transmitted by stylus 200 may for example be similar to that described in U.S. Pat. No. 8,536,471 entitled “Pressure Sensitive Stylus for a Digitizer,” assigned to N-trig and incorporated by reference herein.

According to some embodiments of the present in invention, stylus 200 communicates with digitizer system 100 by two-way communications. In some exemplary embodiments, stylus 200 includes a receiver for receiving commands, a synchronization signal and/or a wake-up signal from digitizer system 100.

According to some embodiments of the present invention, when stylus 200 losses input from digitizer system 100 e.g. responsive to stylus 200 being displaced at a distance from sensor 55, stylus 200 enters a low power sleep mode during which transmission is terminated. Optionally, operation of other electronic elements in stylus 200 is also temporarily terminated.

According to some embodiments of the present invention, the stylus can pick up a signal during a sleep mode and in response to picking up a signal from the digitizer system 100, stylus 200 activates its transmission unit and synchronizes it with the digitizer sensor, so that the stylus transmits over a defined sampling period of the digitizer system for sampling output from the stylus. Typically, additional electronic components are also activated in response to receiving input from digitizer system 100. Various communication methods can be used to provide input and/or transmit a signal to stylus 200 from digitizer system 100. Optional methods include:

### 1. Using Lines 51 as a Communication Channel

In some exemplary embodiments, input to the stylus is provided by transmitting a synchronization signal to lines 51 that can be picked up by stylus 200 when in the vicinity of sensor 50. Optionally, the signal is transmitted over a plurality of lines 51 and/or all lines 51 in at least one axis of sensor 50, e.g. lines 51 in the row direction or lines in the column direction. Typically, communication circuitry 27 manages the synchronization signals transmitted to stylus 200 via lines 51. Optionally, a signal used for communicating with stylus 200 is transmitted concurrently with a triggering signal for triggering mutual capacitance touch detection of finger 46. According to some embodiments of the present invention, a first frequency is used for communicating with stylus 200 and a second frequency is used for triggering mutual capacitance touch detection of finger 46.

### 2. Using a Magnetic Coupling as a Communication Channel

In some exemplary embodiments, digitizer system 100 includes a peripheral communication one or more loops or coil 55 that creates a magnetic field that can be picked up by stylus 200. Optionally, peripheral communication coil 55 is a formed from a planar loop patterned on sensor 50, e.g. around the grid formed from lines 51. Optionally, coil 55 includes a number of planar loops encompassing sensor 50, e.g. 2-15 loops. Optionally, coil 55 is formed from material typically used to connect lines 51 to circuitry 25, e.g. metal runners. Typically, the current that can be transmitted through coil 55 when patterned on sensor 50 may be limited and a relatively high voltage is be used to create a desired magnetic field. Alternatively the peripheral communication coil is patterned on a printed circuit board (PCB) of circuitry 25. Typically, when a coil is formed on a PCB, a relatively higher current and lower voltage is applied as compared to coil 55 formed on sensor 50. Typically, communication circuitry 27 manages signal transmitted to stylus 200 via coil 55.

### 3. Using a Sound as a Communication Channel

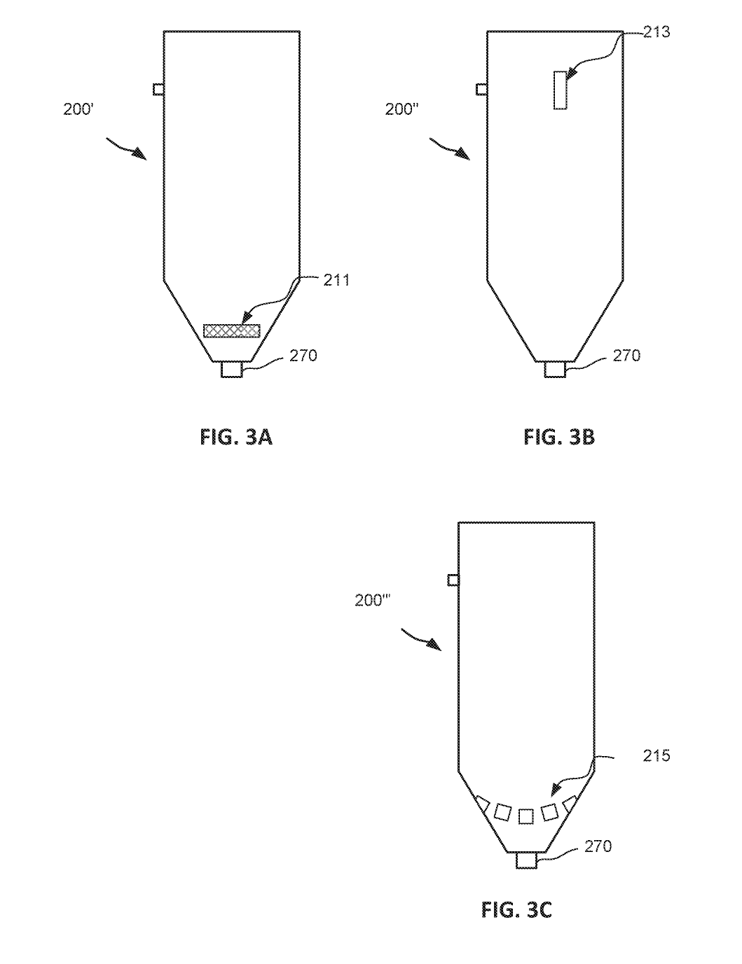

In some exemplary embodiments, digitizer system 100 includes one or more transducers and/or speakers 196 for providing audio tones that can be picked up by stylus 200. Referring now to FIG. 3A, in some exemplary embodiments when audio communication is used, a stylus 200′ includes one or more transducers and/or microphones 211 for detecting audio tones transmitted by speaker 196. Optionally, the audio tones are in the ultrasound range. Referring back to FIG. 1, communication circuitry 27 manages audio tones transmitted to stylus 200 via speaker 196.

### 4. Using an RF Link

In some exemplary embodiments, digitizer system 100 uses an RF link device 180, e.g. Bluetooth, near filed communication (NFC), radio frequency identification (RFID), or Wi-Fi device for example in host 22 and/or in circuitry 25 for communicating with stylus 200 by two-way communication. Referring now to FIG. 3B, in some exemplary embodiments when an RF link is used, stylus 200″ includes matching antenna 213. In some exemplary embodiments, RF link 180 provides for querying stylus 200″. Optionally, stylus 200″ also transmits information to digitizer system 100 using the RF link.

### 5. Using Optical Detection

Referring now to FIG. 3C, in some exemplary embodiments, stylus 200″′ includes a camera and/or one or more photo-detectors 215 that are programmed to detect a defined optical signal. In some exemplary embodiments, photo-detectors 215 detect periodic changes to an image displayed on FPD 45, e.g. due to image refresh or back light flashing. According to some embodiments of the present invention, stylus 200″′ synchronizes its transmission cycle in relation to the detected changes in optical signal as detected by photo-detecting sensors 215. Typically, circuitry associated with photo-detectors 215 is conditioned to detect repetitive changes that occur at known frequency and/or according to a known protocol.

According to some embodiments of the present invention, digitizer system includes a light emitting diode (LED) 198 or other light source that flashes at a pre-defined frequency and/or according to a protocol in synchronization with a sampling period of digitizer system 100 for sampling output of stylus 200. Optionally, LED 198 illuminate in an infrared (IR) range. According to some embodiments of the present invention, photo-detectors 215 detect flashing of LED 198 and stylus 200″′ synchronizes its transmission cycle with the flashing of LED 198.

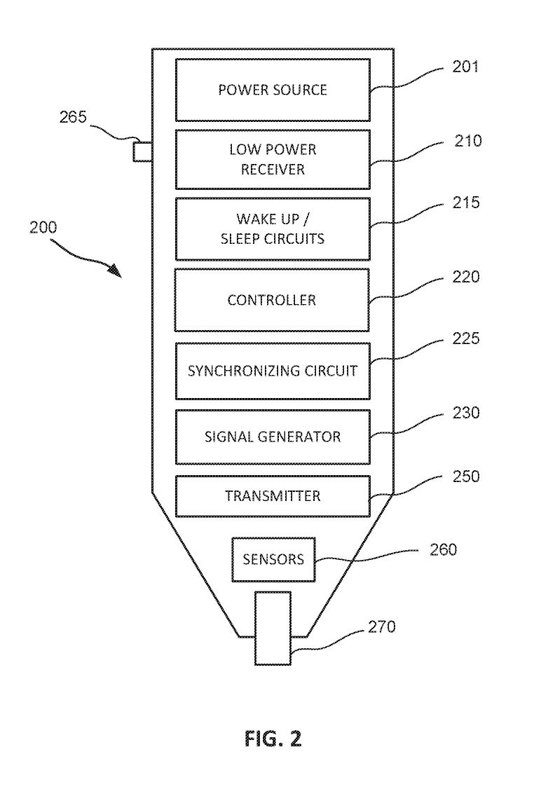

Reference is now also made to FIG. 2 showing a simplified block diagram of exemplary components of a stylus in accordance with some embodiments of the present invention. According to some embodiments of the present invention, stylus 200 is self-powered with a power source 201, e.g. one or more batteries. According to some embodiments of the present invention, stylus 200 includes a low power receiver that is typically operated for receiving input from digitizer system 100. Typically, receiver 210 is matched with a corresponding transmitting unit in digitizer system 100 and can be for example, microphone 211, an RF antenna 213, photo-detector 215. Optionally, lower power receiver 210 also includes transmitting ability so that two way communication can be established with the digitizer sensor 100, e.g. while stylus 200 is in sleep mode.

According to some embodiments of the present invention, a wake-up/sleep circuit 215 prompts stylus 200 to toggle between a wake-up and sleep mode based on input provided by receiver 210. Typically, wake-up/sleep circuit 215 prompts powering of additional components of stylus 200 in response to receiver 210 detecting input from digitizer system 100 and prompts powering off components of stylus 200 in response to an extended absence of input to receiver 210. Optionally, a controller 220 for controlling operation of the additional components is also powered responsive to waking up stylus 200. Typically controller 220 includes memory capability.

According to some embodiments of the present invention, stylus 200 includes a signal generator 230 and a transmitter 250 for generating a signal to be transmitted by transmitter 250. Typically, signal generator 230 and transmitter 250 are operated when stylus 200 is in a wake-up mode and are not operated during a sleep mode, so that power can be saved while the stylus is distanced from digitizer system 100. Optionally, signal generator 230 additionally includes an encoder for encoding information on a signal that is transmitted. Optionally, output from one or more sensors 260 and/or from one or more user activated buttons 265 is encoded on a signal transmitted by stylus 200.

Optionally, sensors 260 include a tip pressure sensor for sensing tip pressure on tip 270.

According to some embodiments of the present invention, synchronizing circuit 225 synchronizes a transmission cycle of stylus 200 with stylus sampling periods of digitizer system 100. In some exemplary embodiments, synchronization is performed when stylus 200 switches to a wake-up mode. Optionally, synchronization circuit 225 periodically updates and/or corrects the synchronization during activation of stylus 200.

According to some embodiments of the present invention, information for synchronizing stylus 200 is obtained from input received by receiver 210. Optionally, synchronizer 225 identifies a timing of the input received and initiates transmission at a pre-defined delay after reception. In some exemplary embodiments, a signal received by receiver 210 is encoded with information and/or includes a command specifying when transmission should be initiated. Optionally, synchronization circuit 225 decodes the information and/or receives the command and initiates transmission accordingly.

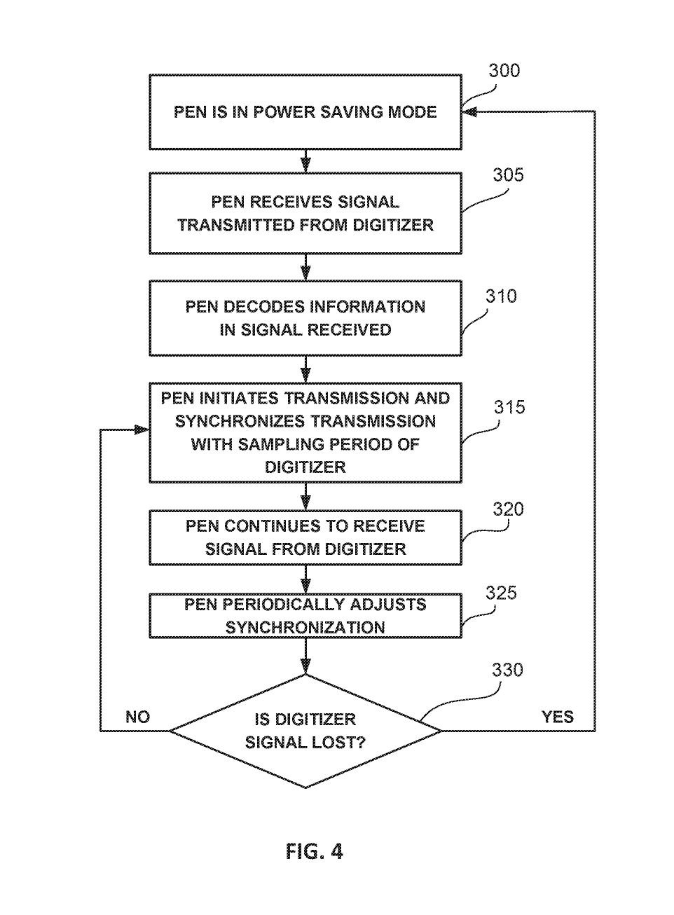

Reference is now made to FIG. 4 showing a simplified flow chart of an exemplary method for operating a stylus in accordance with some embodiments of the present invention. According to some embodiments of the present invention, stylus 200 is stored in a low powered sleep mode (block 300) and is prompted to operation in response to picking up one or more signals transmitted from digitizer system 100. In some exemplary embodiments, input received by digitizer system 100 includes information (block 305) and stylus decodes the information received (block 310). Typically, the information received and/or decoded is used to synchronize transmission of stylus 200 with digitizer system 100. According to some embodiments of the present invention, stylus 200 initiates transmission at the required time (block 315). Typically, stylus 200 transmits a signal burst and/or pulse at a defined repetition rate or according to a defined communication protocol. Typically, the signal transmitted is used to locate a position of stylus 200 with respect to digitizer sensor 50. Optionally, information related to operation and/or identification of the stylus is also transmitted by stylus 200 together with transmission of the position signal.

According to some embodiments of the present invention stylus 200 continues to transmit signal bursts as long as input is received by digitizer system 100, e.g. at a pre-defined rate (block 320). Optionally, over the course of repeated transmission, input provided by the digitizer system 100 is periodically decoded and/or analyzed to update, adjust and/or improve synchronization between stylus 200 and digitizer system 100 (block 325). According to some embodiments of the present invention, if the digitizer signal is lost (block 330), the stylus is prompted to enter a sleep mode. Typically, sleep mode is initiated only after a pre-defined number of inputs from digitizer system have been missed and/or a pre-defined period of time with no input has lapsed.

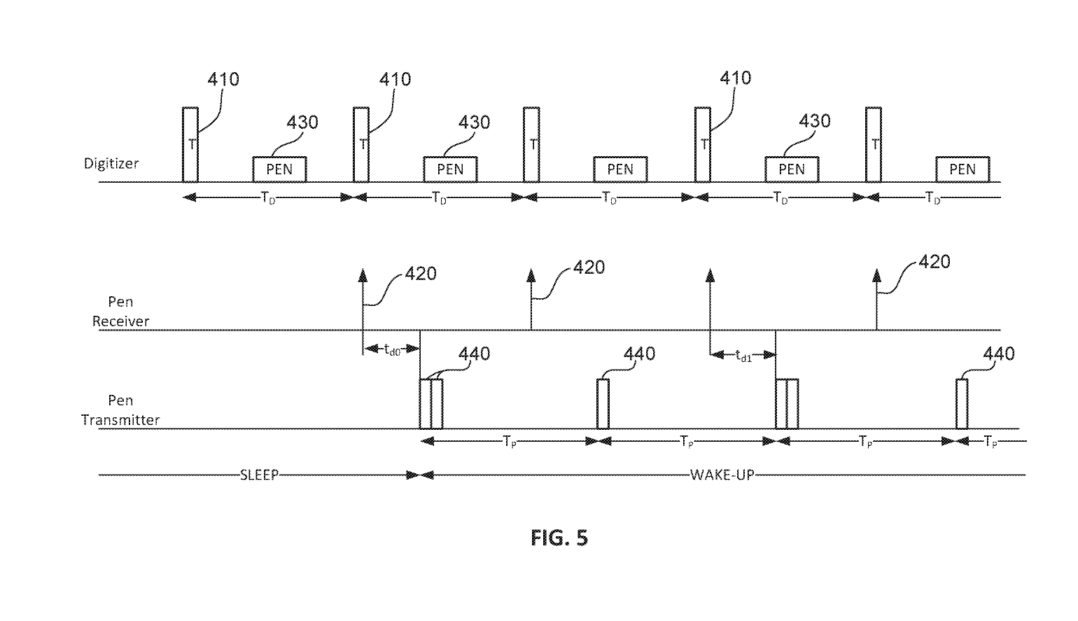

Reference is now made to FIG. 5 showing a simplified time diagram illustrating a method for waking up a stylus and synchronizing its transmission with a corresponding sampling window of a digitizer system in accordance with some embodiments of the present invention. Block 410 represents a period over which digitizer system 100 transmits a signal to stylus 200, block 430 represents a period over which digitizer system 100 samples output from lines 51 to detect a stylus signal and T_{D} represents a period of a transmission cycle of the digitizer system 100. It is noted that the duration of the time blocks 410 and 430 may be exaggerated with respect to period T_{D} for clarity purposes. According to some embodiments of the present invention, stylus 200 detects transmission 410 as stylus 200 approaches digitizer sensor 50. Typically, stylus 200 begins to detect transmission 410 while hovering over sensor 50. According to some embodiments of the present invention, while stylus 200 is in a sleep mode, stylus 200 receives a signal from digitizer system 100 at a time 420. Typically, stylus 200 identifies that the signal is a pre-defined signal that has been transmitted by digitizer system 100 and switches to a wake-up mode. Alternatively, stylus 200 only switches to a wake-up mode after identifying a plurality of transmissions 410.

According to some embodiments of the present invention, stylus 200 is operative to synchronize a transmission period, Tₚ, of stylus 200 with timing 420. In some exemplary embodiments, stylus 200 is synchronized to transmit one or more pulse signals 440, e.g. a train of pulses at a defined delay t_{d0} from identified timing 420.

According to some embodiments of the present invention, stylus 200 continues to transmit pulses 440 as long as input 410 is detected by stylus 200. Optionally, one pulse 440 provides a position signal and additional pulses in the same cycle provide encoded information. In some exemplary embodiments, stylus 200, updates, corrects and/or improves synchronization by occasionally analyzing timing 420 and/or information received from transmission 410. Adjustments may be initiated by one or more of digitizer system 100 and stylus.

It is noted that a period over which digitizer system 100 samples output from lines 51 for fingertip 46 detection is not shown on the time line for clarity purposes. Typically, a sampling period for fingertip detection occurs any time during T_{D} that is not occupied by sampling block 430. In some exemplary embodiments, the sampling period for fingertip detection overlaps transmission block 410. Optionally, fingertip detection is not performed during each cycle T_{D}, but may alternatively be performed for example ever other cycle.

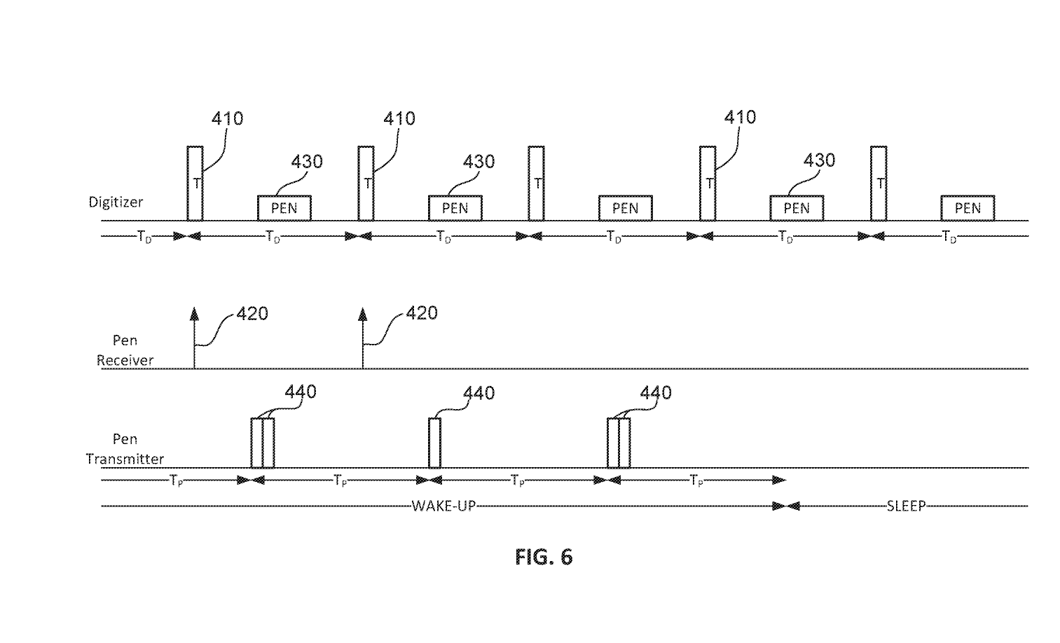

Reference is now made to FIG. 6 showing a simplified time diagram illustrating a method for switching back to a sleep mode in accordance to some embodiments of the present invention. According to some embodiments of the present invention, transmission of pulses 440 continues until a pre-defined time has elapsed since a transmission 410 has been lost. According to some embodiments of the present invention, stylus 200 is prompted into a sleep mode in response to loss of signal 410. Stylus 200 fails to detect transmission 410 when stylus 200 is displaced from digitizer system 100 or when digitizer system 100 is turned off. Optionally, the proximity of stylus 200 to digitizer sensor 50 required to activate a wake-up mode is predefined.

Optionally, stylus 200 is only activated when a tip of the stylus is positioned at a pre-defined distance from sensor 50.

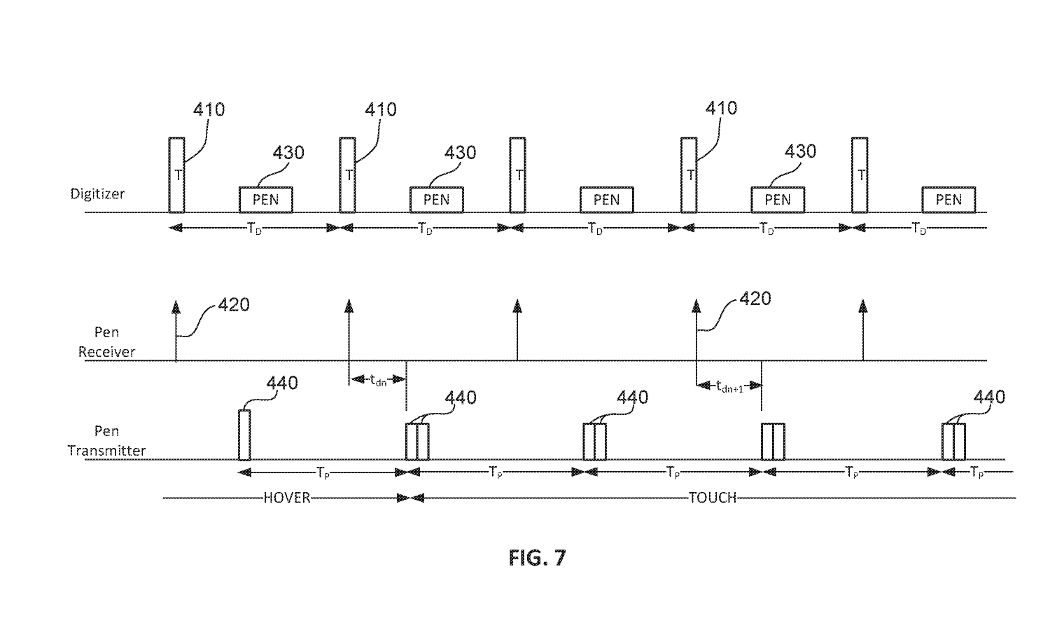

Reference is now made to FIG. 7 showing a simplified time diagram illustrating a method for operating a stylus during a hover and a touch operational state in accordance with some embodiments of the present invention. According to some embodiments of the present invention, during operation of stylus 200, stylus 200 may switch from a hover mode to a touch mode. In some exemplary embodiments, a repetition rate and/or a number of pulses per T_{P} that is transmitted by stylus 200 increases or otherwise changes during a touch operational mode of stylus 200.

Optionally, during a hover operational mode, transmission 440 occurs for example once every other transmission period T_{P} and during a touch operational state, transmission 440 occurs at least once every transmission cycle T_{P}. Optionally, stylus 200 transmits a higher amplitude signal hover as compared to amplitude of signal transmitted during a touch operational mode. Typically, the duration of transmission cycle T_{P} is matched to the refresh cycle of digitizer system 100, T_{D}.

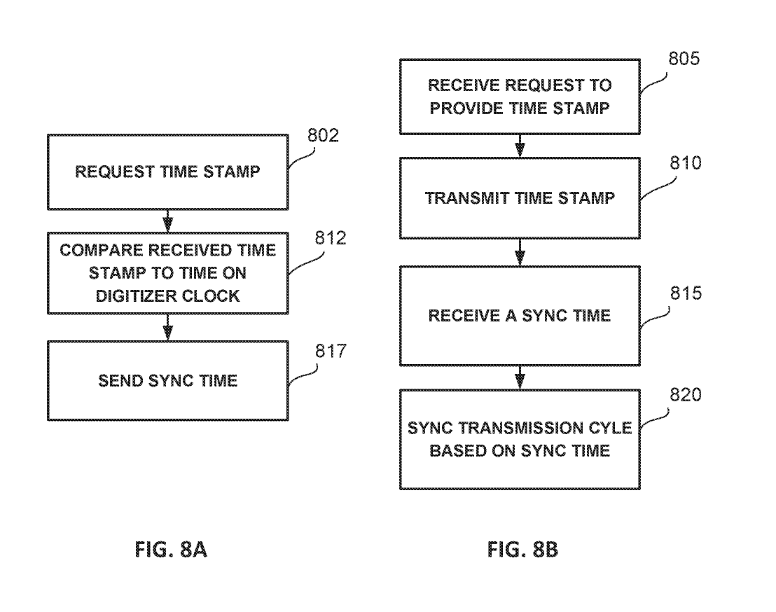

Reference is now made to FIGS. 8A and 8B showing simplified flow charts of an exemplary method for using an RF link for establishing two-way communicating between a stylus and a digitizer system in accordance with some embodiments of the present invention. According to some embodiments of the present invention, the RF link can be used as a low power method for establishing two-way communication between stylus 200 and digitizer system 100. According to some embodiments of the present invention, the RF link antenna of digitizer system 100 sends a query to stylus 200 requesting a time stamp (block 802). The request is received by the RF link antenna of stylus 200 (block 805) and the time stamp representing a time that the stylus received the query is transmitted to the digitizer system (block 810). According to some embodiments of the present invention, the time stamp is transmitted via tip 270 typically used to transmit the position signal of the stylus. In some exemplary embodiments, one or more lines 51 of digitizer system 100 receive the input and digitizer system 100 compares the received time stamp with a time on a real clock of digitizer system 100 (block 812). Based on the comparison, digitizer system 100 determines a time on a real time clock of stylus 200 for the stylus to initiate a transmission cycle for transmitting for example a stylus position signal (block 807). Typically, synchronization between digitizer system 100 and stylus 200 is improved by transmitting the time stamp with the same communication line and/or path used for transmitting the position signal, e.g. stylus tip 270 and lines 51 since any delays that are incurred during transmission of the time stamp will be the same as those that occur when transmitting the stylus position.

This synchronization time is transmitted to and received by the RF link antenna of stylus 200 (block 815). Optionally, the RF link antenna is the same antenna used for transmitting the stylus position signal. According to some embodiments of the present invention, stylus 200 transmits its position signal and/or other information at a defined delay with respect to the received synchronization time (block 820). Typically, digitizer system 100 translates between the clocks of digitizer system 100 and stylus 200, and stylus 200 transmits signals at times as requested by digitizer system 100 but in accordance with the stylus clock. Stylus 200 receives communications from digitizer system 100 via the RF link.

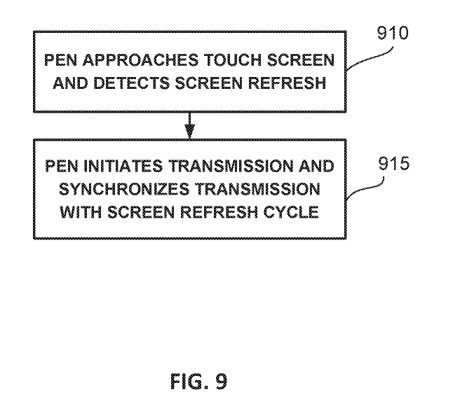

Reference is now made to FIG. 9 showing a simplified flow chart of exemplary method for synchronizing transmission of a stylus with a digitizer system by detecting screen refresh in accordance with some embodiments of the present invention.

According to some embodiments of the present invention, as the stylus approaches FPD 45, one or more photo detectors positioned on the stylus detects a timing at which the FPD is refreshed (block 910). In some embodiments, the photo detector can differentiate when a certain area of the display, for example a certain horizontal line is refreshed. The stylus may then synchronize its transmission with such a refresh event, for example the refresh of a predetermined line of the display.

According to some embodiments of the present invention, the stylus transmission is initiated and the timing of the transmission is synchronized with the timing for refreshing FPD (block 915). Typically digitizer system 100 synchronizes sampling of the stylus signal with refreshing of FPD so that when stylus 200 is synchronized with FPD it can also synchronized with a stylus sampling period of digitizer system 100.

Optionally, an additional communication link is used to allow digitizer system 100 to inform stylus 200 as to when to transmit relative to refresh timing of FPD.

Alternatively, a pre-defined delay for transmitting the stylus signal is stored in the stylus memory.

It is noted that digitizer system 100 described herein may be suitable for any computing device that enables interactions between a user and the device, e.g. mobile computing devices that include, for example, FPD screens. Examples of such devices include Tablet PCs, pen enabled lap-top computers, tabletop computer, PDAs or any hand held devices such as palm pilots and mobile phones.

It is noted that various components have been labeled as discrete circuits in the drawings for the purpose of simplification purposes. However, it is clear that one physical component, e.g. an application specific integrated circuit (ASIC), can provide functionality of multiple circuits and/or alternatively functionality of one circuit may be provided by a plurality of physical components.

Although most of the embodiments of the present invention have been described with reference to operation of a stylus with a digitizer sensor, it would be clear to a person of ordinary skill in the art that the invention is limited in this respect so that systems and/or methods described herein can also be applied to other signal emitting objects for interaction with a digitizer sensor and/or touch screen.

Although most of the embodiments of the present invention have been described with reference to a grid based mutual capacitive sensor, it would be clear to a person of ordinary skill in the art that the invention is not limited in this respect so that the systems and/or methods described herein may also be applied to other types of digitizer sensors and/or touch screen that are not grid based and/or capacitive based.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

1. A method for operating a stylus with a digitizer system, the method comprising:
receiving a signal that is repeatedly transmitted by the digitizer system according to a pre-defined protocol of the digitizer system, the protocol being known to the stylus;
transmitting position signals in synchronization with the signal transmitted by the digitizer system; and
continuing transmission of the position signals over a duration that the stylus receives the repeated transmissions of the digitizer system according to the pre-defined protocol.

2. The method of claim 1 comprising:
operating the stylus in a sleep mode, wherein the stylus is powered to receive input during the sleep mode but is not powered to transmit the position signals during the sleep mode;
receiving the signal that is repeatedly transmitted by the digitizer system while the stylus is in the sleep mode;
switching the stylus to a wake-up mode responsive to detecting the signal transmitted by the digitizer system; and
maintaining the stylus in the wake-up mode over the duration that the stylus receives the repeated transmissions of the digitizer system according to the pre-defined protocol.

3. The method of claim 2, comprising reassuming a sleep mode after a pre-defined period in which the signal transmitted by the digitizer system is not received.

4. The method of claim 2, comprising powering generation of the position signal with a power source internal to the stylus responsive to switching the stylus to a wake-up mode.

5. The method of claim 2, comprising powering a tip pressure sensor within the stylus responsive to switching the stylus to a wake-up mode.

6. The method of claim 1, wherein the synchronization includes transmitting the position signals with a pre-defined delay from receipt of the signal transmitted by the digitizer system.

7. The method of claim 1, wherein the signal received by the stylus is encoded with information for synchronizing transmission of the position signal and wherein the stylus decodes the information and uses it to synchronize transmission of the position signal.

8. The method of claim 7, wherein the encoded information includes a defined delay period for transmitting the position signal.

9. The method of claim 1, comprising adjusting the synchronization of the stylus during the repeated transmissions of the digitizer system.

10. The method of claim 1, wherein the signal transmitted by the digitizer system and received by the stylus is selected from a group including: an electromagnetic signal, an RF signal, a sonic signal, and an optical signal.

11. The method of claim 10, wherein the optical signal is provided by a display screen associated with the digitizer system.

12. The method of claim 10, wherein the optical signal is a synchronization signal associated with a refresh timing of a display screen of the digitizer system.

13. The method of claim 1, wherein the pre-defined protocol of the digitizer system is synchronized with sampling windows of the digitizer system for sampling output from a digitizer sensor of the digitizer system.

14. The method of claim 1, wherein the position signal is a pulse signal that is transmitted according to the pre-defined protocol of the digitizer system.

15. The method of claim 1, comprising transmitting with the stylus an encoded signal in synchronization with the timing at which the signal is received.

16. The method of claim 15, wherein the encoded signal includes information regarding tip pressure applied on a tip of the stylus.

17. The method of claim 15, wherein the encoded signal includes information regarding one or more of the following: stylus identification, battery power state, and state of user activated buttons.

18. The method of claim 1, wherein the digitizer system includes a digitizer sensor that is a grid based capacitive sensor.

19. The method of claim 18, wherein the signal transmitted by the digitizer system is transmitted by conductive lines of the grid based capacitive sensor.

20. The method of claim 18, wherein the digitizer system is operated to detect finger touch.

21. The method of claim 20, wherein the signal transmitted by the digitizer system is transmitted concurrently with triggering the grid based capacitive sensor for fingertip touch detection.

22. The method of claim 1, wherein the signal transmitted by the digitizer system is transmitted with a conductive loop patterned around a sensing surface of the digitizer system.

23. The method of claim 1, the signal transmitted by the digitizer system is transmitted with an RF link included in a host computer associated with the digitizer system.

24. The method of claim 1, wherein the digitizer system includes a touch screen.
